(19) United States
(12) Patent Application Publication
(10) Pub. No.: US 2012/0179605 A1
(43) Pub. Date: Jul. 12, 2012

(54) SYSTEM FOR ALLOWING A USER TO CONTROL THE MANNER AND AMOUNT PAID TO SETTLE ACCOUNT TRANSACTIONS

(75) Inventors: Joe Blain, Milton, MA (US); Jeffrey Jacocks, Jamaica Plain, MA (US); Andrea Tittel, Boston, MA (US); Geoff Thomas, Needham, MA (US)

(73) Assignee: CITIZENS FINANCIAL GROUP, INC., Providence, RI (US)

(21) Appl. No.: 12/985,902

(22) Filed: Jan. 6, 2011

(51) Int. Cl. G06Q 40/00

(52) U.S. Cl. 705/40

(57) ABSTRACT

A method and system is provided that allows a banking customer to manage repayment of larger bills by breaking them into a series of smaller more manageable payments that are repaid over a number of payments that are spread over a longer period of time. As bills are presented to the bank account customer, the customer, using the user interface can select one of the bills due for payment and request that they be allowed to break the bill into smaller payments. Once approved the larger bill is broken into a predetermined number of smaller repayments that are then more easily managed by the customer in a manner that eases their cash flow.

### BACKGROUND OF THE INVENTION

The present invention relates generally to a method and system that allows a banking customer to manage repayment of larger bills by breaking them into a series of smaller payment transactions that are paid over a period of time. More specifically, the present invention relates to a method and system that allows a banking customer to access their bank account via an online banking interface and break large bills down into smaller more manageable payments that are repaid over a number of payments that are spread out over a longer period of time.

Consumers today are rapidly changing the manner in which they conduct monetary transactions. Most consumers are moving away from a transaction wherein they pay for goods and services with cash or checks. Instead these consumers are turning to the use of electronic transaction cards in the form of credit or debit cards. Consumers often find themselves using such electronic transaction cards for completing even the smallest everyday purchase, such as buying their morning coffee. Such electronic transaction cards then allow the customer to complete the transaction whereby money is transferred from a consumer account linked to the card to the provider of the goods and/or services. Often however this frequent use of electronic transaction cards for numerous purchases each day creates a flurry of activity that can be difficult for the consumer to track. When the balance in the account linked to the electronic transaction card gets low, an unsuspecting consumer can rack up several small charges that overdraft their account in turn accruing overdraft fees. In this regard there have been many recent news stories that include accounts of consumers, who in charging a coffee, accrued overdraft charges that ultimately resulted in that one coffee costing a consumer over $30 by the all of the charges were added up.

Further, there is a growing popularity surrounding the use of online banking to assist consumers in managing their finances and to receive and pay bills. These online interfaces allow consumers to electronically track various accounts and other financial endeavors. Additionally, the user can receive electronic billing in their account or if the user receives a paper bill, enter them into their computers, and manage payment of the bills electronically. The consumer then creates payment instructions in the online banking interface. For recurring bills, such as a mortgage, the consumer can also arrange so-called “direct debit” payment systems in which routine payment amounts are automatically debited from the consumer's bank account and credited to the biller's bank account on agreed transaction dates. The problem that arises here is that the accounts used in this fashion are typically the same accounts that are tied to the electronic transaction cards described above thereby making the flow of transaction in the account even more dynamic.

This dynamic flow of transactions through the user's account may often be difficult to manage or keep careful track of. While the automated computer systems maintain account balances with precision a consumer may lose track of a few purchases that they made along the way resulting in an overdraft condition in their bank account. Further, when enrolled for online banking and bill payment services, a customer may be confronted with a large bill that was unexpected until it arrived into the electronic payment queue. In such a position the customer must find a way in which to manage their cash flow in order to make the required payment by transferring or depositing additional funding into the bill pay account. Otherwise the bill may be paid late or not paid at all. One can easily see that over time, poorly managed cash flow can quickly become expensive and damaging for a consumer.

Accordingly, there is a need for a method and system that allows a banking customer to manage repayment of larger bills by breaking the payment of the bill into a series of smaller payment transactions that are paid over a period of time in a manner that allows the customer to manage their cash flow. There is a further need for a method and system that allows a banking customer to access their bank account and break large bills down into smaller more manageable payments that are repaid over a number of payments spread over a longer period of time in a manner that allows the customer to manage their cash flow.

### BRIEF SUMMARY OF THE INVENTION

In this regard, the present invention provides a method and system that allows a banking customer to manage repayment of larger bills by breaking them into a series of smaller payment transactions that are paid over a period of time. More specifically, the present invention provides to a method and system that allows a banking customer to access their account bank account via an online banking interface and break large bills down into smaller more manageable payments that are repaid over a number of payments that are spread out over a longer period of time.

In the context of the method and system of the present invention a customer maintains a banking account or establishes a new banking account such that the banking account contains a monetary balance therein. The banking account is an account that includes online bill payment features and customer access via a user interface that is connected to the account through an electronic communications network such as the Internet. As bills are presented to the bank account customer, the customer, using the user interface can access the account, select one of the bills that are due for payment and request that they be allowed to break the bill into smaller payments. Provided the customer qualifies, they then select a repayment schedule that complies with pre-established rules, such as at least one monthly payment. The larger bill is then broken into several smaller payments that are then more easily managed by the customer in a manner that eases their cash flow.

It should also be appreciated that in the context of the present invention, a fee may be established for this account feature. The fee may be a singular fee that is paid for use of the feature. In a preferred embodiment, the fee is established as a fixed charge per installment payment. If the customer divides the bill into three payments, then they would pay three flat fees that are assessed at the time of each payment. If the customer then pays of the bill ahead of schedule, then the customer is only charged the per payment fee for the number of payments made. Further, the fee may be structure in a manner that different customers may be charged different or even no fees depending on the overall banking services that they use.

Accordingly, it is an object of the present invention to provide a method and system that allows a banking customer to manage repayment of larger bills by breaking the payment of the bill into a series of smaller payment transactions that are paid over a period of time in a manner that allows the customer to manage their cash flow. It is a further object of the present invention to provide a method and system that allows a banking customer to access their bank account and break large bills down into smaller more manageable payments that are repaid over a number of payments spread over a longer period of time in a manner that allows the customer to manage their cash flow.

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a flow chart depicting operation of the method and system of the present invention; and

FIG. 2 is a schematic of a computer implemented system to support operation of the method and system of the present invention.

### DETAILED DESCRIPTION OF THE INVENTION

Now turning to the method and system of the present invention in detail. As can be understood, the present invention most generally provides for a method and system that allows a banking customer to manage repayment of larger bills by breaking the larger bill amount into a series of smaller payment transactions that are then repaid over a period of time. This allows a banking customer to access their account bank account via an online banking interface and break large bills down into smaller more manageable payments that are repaid over a number of payments that are spread over a longer period of time in a manner that allows the customer flexible cash flow management.

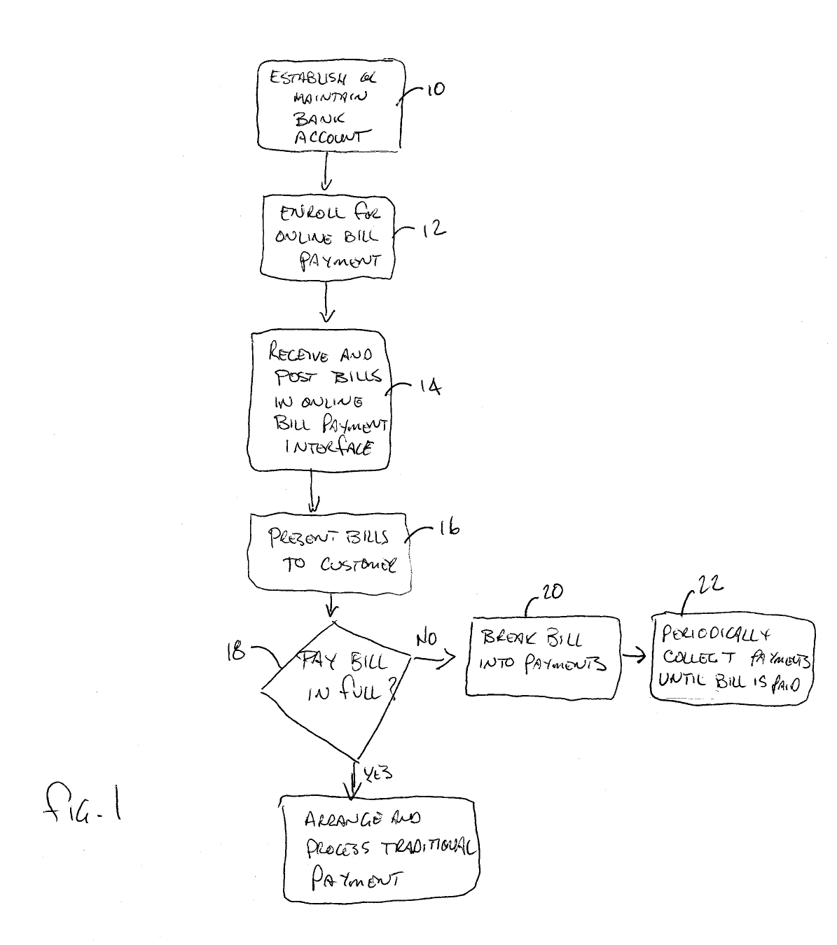

Turning now to FIG. 1, a flow chart is shown that depicts the specific the context of the method and system of the present invention. A customer maintains an existing banking account or establishes a new banking account 10 at a bank service provider such that the banking account 10 contains a monetary balance therein. The banking account 10 is an account such as a checking account, a savings account or a money market account that includes online bill payment features 12 and access thereto via a user interface that is connected to the account through an electronic communications network such as the Internet.

As is known in the prior art, the customer, via the user interface enrolls for online bill payment 12 within the account 10. By using online bill payment 12, a biller presents an electronic bill for the goods or services used by the customer directly into the customer's banking account user interface 14. Once the online bill payment request is processed, as new bills are posted into the user interface such that the customer is presented with them each time they access their account 16. The customer then elects to schedule payment of the bills presented. Traditionally, in the prior art, the customer then elects to pay the amount of the bill and establishes the date on which the full amount of the bill will be paid.

In contrast to the prior art, the method and system of the present invention provides an alternative option for payment of the bills that are presented within the user interface. In accordance with the present invention, as bills are presented 16, the customer is provided with an option to select one of the bills due for payment and request that they be allowed to break the bill into smaller payments 18. Provided the customer qualifies, they then select a repayment schedule that complies with pre-established rules, such as at least one monthly payment and/or at least a minimum payment amount. The larger bill is then broken into at least two or more smaller payments 20 that are then more easily managed by the customer in a manner that eases their cash flow. The bank service provider then periodically collects the smaller payments from the banking account until the total amount is paid 22.

In operation therefore, by way of example, a customer upon accessing their account is presented with a bill of $375 from a service provider. The customer requests that the payment of the $375 be broken into three monthly payments of $125 each. Once the request is approved the larger payment is broken down and the customer makes three smaller monthly payments rather than the single larger payment. Clearly, in the context of the process outlined above, customers may be prescreened before the program is made available to them. Such prescreening may involve an analysis of the customer's credit history, historic bank balances and their overall ability to pay the bill in a timely manner. This allows the bank service provider to manage any risk that may arise from allowing the larger payments to be stretched out over time.

It should also be appreciated that in the context of the present invention, a fee may be established for this account feature. The fee may be a singular fee that is paid for use of the feature. In a preferred embodiment, the fee is established as a fixed charge per installment payment. If the customer divides the bill into three payments, then they would pay three flat fees that are assessed at the time of each payment. In the example above, if the fee per payment were established at $10 then each of the three payments made by the customer would be $135. If the customer then pays of the bill ahead of schedule, then the customer is only charged the per payment fee for the number of payments made. For example, the customer may make the first $135 payment and then pay the remaining balance of $250 plus only one more $10 payment fee. It should also be appreciated the while three payments has been shown by way of example, the present invention applies to any number of two or more payments. Further, while an equal division of payments is shown, any manner of breaking the larger payment into several smaller payments is intended to fall within the scope of the present invention. Still further, the fee may be structure in a manner that different customers may be charged different or even no fees depending on the overall banking services that they use. For example, the bank service provider may charge a monthly fee for a customer to have this feature activated on their account. It is also possible that the fee may be structured in a manner that different customers may be charged different or even no fees depending on the overall banking services that they use. For example, a customer of a basic checking account may pay a per payment fee to have this feature activated on their account while a consumer of a top tier account bundle that includes several accounts, bank service features and minimum maintained balances may receive this feature for nominal or no charge.

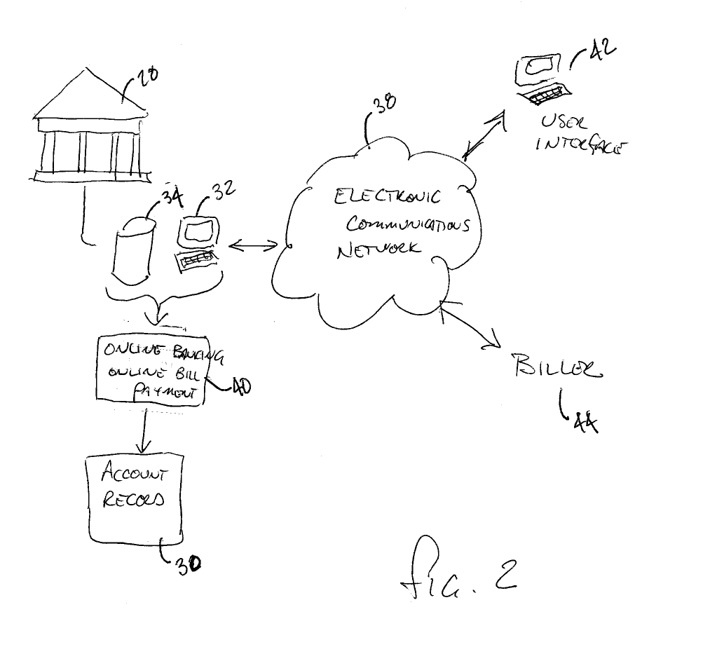

Turning to FIG. 2, the present invention is illustrated in the context of a computer implemented system wherein a customer maintains an existing bank account or establishes a new banking account at a bank service provider 28 that resides as a record 30 on a computer server 32 or database system 34. The account record 30 contains a monetary balance therein that is recorded and tracked within the record 30 within the computer server 32 or database 34. In the preferred embodiment the computer server 32 or database system 34 is connected to an electronic communications network 38 that, in turn, allows electronic access to the account record 30. It is preferred that the banking account is established in a manner that allows electronic access thereto via the electronic communications network 38 for the purpose of online bill payment features 40.

The customer accesses and utilizes the online bill payment features 40 of their account via a user interface 42 that is also in communication with the electronic communications network 38. In operation the online bill payment system 40 allows a biller 44 to present an electronic bill for the goods or services used by the customer directly into the customer's banking account user interface. Once the online bill payment request is processed, as new bills are posted into the user interface such that the customer is presented with them each time they access their account. The customer then elects to schedule payment of the bills presented. Traditionally, in the prior art, the customer then elects to pay the amount of the bill and establishes the date on which the full amount of the bill will be paid.

In contrast to the prior art, the method and system of the present invention provides an alternative option for payment of the bills that are presented within the user interface. In accordance with the present invention, as bills are presented, the customer is provided with an option to select one of the bills due for payment and request that they be allowed to break the bill into smaller payments. Provided the customer qualifies, they then select a repayment schedule that complies with pre-established rules, such as at least one monthly payment and/or at least a minimum payment amount. The larger bill is then broken into at least two or more smaller payments that are then more easily managed by the customer in a manner that eases their cash flow.

It can therefore be seen that the present invention provides a method and system that allows a banking customer to manage repayment of larger bills by breaking the payment of the bill into a series of smaller more manageable payments that are repaid over a number of payments spread over a longer period of time in a manner that allows the customer to manage their cash flow. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

1. A method for paying bills within a bill payment system feature of an electronic banking account, comprising:
maintaining an electronic banking account as a computer record on at least one database of a bank service provider system;
enrolling said banking account into an online bill payment system that is accessible via an electronic communications network;
receiving at least one bill having an amount to be paid within said online bill payment system;
presenting said at least one bill, over said electronic communications network, to a user for payment via a user interface embodied in a personal computing device when the user accesses said banking account via said user interface;
dividing the amount of the bill into at least two smaller payments in response to a user request; and
periodically collecting one of said smaller payments from the banking account until the total amount is paid.

2. The method of claim 1, further comprising:
charging a fee for dividing the amount of the bill into at least two smaller payments.

3. The method of claim 2, wherein said fee is a periodic fee that is added to each of said smaller payments and the total amount paid includes the bill amount to be paid plus each of the periodic fees.

4. The method of claim 2, wherein said fee is a flat fee that is added to the bill amount to be paid.

5. The method of claim 2, wherein said fee is waived if the user utilizes a bundle of services offered by said bank service provider.

6. The method of claim 1, wherein said banking account is selected from the group consisting of: a checking account, a money market account and a savings account.

7. The method of claim 1, wherein said banking account is an existing bank account.

8. The method of claim 1, wherein said banking account is a newly established bank account.

9. A method for paying bills within a bill payment system feature of a banking account, comprising:
presenting at least one bill having an amount to be paid to a user when the user accesses a bill payment system via a user interface embodied on a personal computing device;
dividing the amount of the bill into at least two smaller payments via said personal computing device; and
periodically collecting one of said smaller payments from an electronic banking account associated with the user until the total amount is paid.

10. The method of claim 9, further comprising:
charging a for dividing the amount of the bill into at least two smaller payments.

11. The method of claim 10, wherein said fee is a periodic fee that is added to each of said smaller payments and the total amount paid includes the bill amount to be paid plus each of the periodic fees.

12. The method of claim 10, wherein said fee is a flat fee that is added to the bill amount to be paid.

13. The method of claim 10, wherein said fee is waived if the user utilizes a bundle of services offered by said bank service provider.

14. A computer implemented system for paying bills within a bill payment system feature of a banking account, comprising:
a banking account maintained as a computer record on a database at a bank service provider, said banking account associated with an online bill payment system, said banking account accessible via an electronic communications network, wherein at least one bill having an amount to be paid is presented directly to said banking account via said online bill payment system; and
a user interface embodied in a personal computing device for accessing said banking account and said online bill payment system, in communication with the electronic communications network, wherein said at least one bill is presented to a user when the user accesses said banking account via said user interface;
the user interface configured for dividing the amount of the presented bill into at least two smaller payments, the bank service provider periodically collecting one of said smaller payments from said banking account until the total amount is paid.

15. The system of claim 14, wherein a fee is charged for dividing the amount of the bill into at least two smaller payments.

16. The system of claim 15, wherein said fee is a periodic fee that is added to each of said smaller payments and the total amount paid includes the bill amount to be paid plus each of the periodic fees.

17. The system of claim 15, wherein said fee is a flat fee that is added to the bill amount to be paid.

18. The system of claim 15, wherein said fee is waived if user associated with the banking account utilizes a bundle of services offered by said bank service provider.

19. The system of claim 15, wherein said banking account is selected from the group consisting of a checking account, a money market account and a savings account.
